(19) United States
(12) Patent Application Publication
(10) Pub. No.: US 2026/0295756 A1
(43) Pub. Date: Oct. 1, 2026

(54) Automated Machining Process for Manufacturing Parts

(71) Applicant: The Boeing Company, Arlington, VA (US)

(72) Inventor: Justin Lee Peters, Carrollton, IL (US)

(21) Appl. No.: 19/379,970

(22) Filed: Nov. 5, 2025

Related U.S. Application Data
(60) Provisional application No. 63/778,566, filed on Mar. 27, 2025.

(51) Int. Cl. B23Q 15/22; G05B 19/4093; G05B 19/414

(52) U.S. Cl. CPC B23Q 15/22; G05B 19/40931; G05B 19/414

(57) ABSTRACT

A method for manufacturing a part. Volumetric representations are created for a three dimensional model scheme of the part, a stock, and a fixture for holding the part. Input values are determined for input variables used for planning a machining of the part. Machining parameters are determined using the volumetric representations and the input values for the input variables. Tool path processes are created using the machining parameters. Machining processes are created using the tool path processes, the volumetric representations, and the input values for the input variables. The machining processes are used to manufacture the part.

### CROSS-REFERENCE TO RELATED APPLICATION

This application claims the benefit of U.S. Provisional Patent Application Serial No. 63/778,566, filed Mar. 27, 2025, and entitled “Automated Machining Process for Manufacturing Parts,” which is incorporated herein by reference in its entirety.

### BACKGROUND INFORMATION

### 1. Field

The present disclosure relates generally to part manufacturing and in particular, to machining parts using automated machining processes.

### 2. Background

Parts are manufactured using different manufacturing techniques. For example, parts can be manufactured using machining in which a machine operates to remove material from a blank or a fabrication piece to create the part. Model based engineering (MBE) machining can be used to manufacture parts from digital three dimensional models of the parts.

With model based engineering machining, a computer-aided design model (CAD) and product manufacturing information are used by a computer-aided manufacturing (CAM) system to generate tool paths, manage tolerances, and manage workflows for product manufacturing information. The computer-aided manufacturing (CAM) system can generate a program comprising program instructions that are used to guide and control the operation of a numeric control (NC) machine. A numeric control machine can be a lathe, a mill, a router, or other suitable tools that operate to create parts having dimensions within desired tolerances.

The program generated by the computer-aided manufacturing system specifies tool paths, feed rates, spindle speeds, coding sequences, and other information used to machine materials to form parts. This type of machine using a program generated from a computer-aided design model can provide high levels of precision with repeatability to manufacture parts from different materials including aluminum, steel, plastics, and composites.

### SUMMARY

An embodiment of the present disclosure provides a manufacturing system for manufacturing a part. The manufacturing system comprises a computer system and workflow manager in the computer system. The workflow manager is configured to perform operations comprising creating volumetric representations for a three dimensional model scheme of the part, a stock, and a fixture for holding the part; determining values for input variables used for planning machining of the part; determining machining parameters using the volumetric representations and the values for the input variables; creating tool path processes using the machining parameters and the volumetric representations; and creating machining processes using the tool path processes, the volumetric representations, and the input values for the input variables, wherein the machining processes are used to manufacture the part.

Another embodiment of the present disclosure provides a manufacturing system comprising a computer system and workflow manager in the computer system. The workflow manager is configured to perform operations comprising determining machining parameters using volumetric representations, a part, a stock, and a fixture in a three dimensional model scheme and input values for input variables used for planning a machining of the part; creating tool path processes using the machining parameters and the volumetric representations; and creating machining processes using the tool path processes, the volumetric representations, and the input values for the input variables, wherein the machining processes are used to manufacture the part.

Yet another embodiment of the present disclosure provides a method for manufacturing a part. Volumetric representations are created for a three dimensional model scheme of a part, a stock, and a fixture for holding the part. Input values are determined for input variables used for planning a machining of the part. Machining parameters are determined using the volumetric representations and the input values for the input variables. Tool path processes are created using the machining parameters. Machining processes are created using the tool path processes, the volumetric representations, and the input values for the input variables. The machining processes are used to manufacture the part.

Still another embodiment of the present disclosure provides a method for manufacturing a part. Machining parameters are determined using volumetric representations for a three dimensional model scheme of a part, a stock, and a fixture and input values for input variables used for planning machining of the part. Tool path processes are created using the machining parameters. Machining processes are created using the tool path processes, the volumetric representations, and the input values for the input variables, wherein the machining processes are used to manufacture the part.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a manufacturing environment in accordance with an illustrative embodiment;

FIG. 3 is an illustration of a block diagram of a standardized format in accordance with an illustrative embodiment;

FIG. 4 is an illustration of a process flow for manufacturing a physical part in accordance with an illustrative embodiment;

FIG. 5 is an illustration of a template in accordance with an illustrative environment;

FIG. 6 is an illustration of a completed template in accordance with an illustrative embodiment;

FIG. 7 is an illustration of a flow path for manufacturing a part in accordance with an illustrative embodiment;

FIG. 8 is an illustration of a flow path for creating a template using a number of data structures in accordance with an illustrative embodiment;

FIG. 9 is an illustration of a flowchart of a process for manufacturing a part in accordance with an illustrative embodiment;

FIG. 10 is an illustration of a flowchart of a process for manufacturing a part in accordance with an illustrative embodiment;

FIG. 11 is an illustration of a flowchart of a process for controlling an operation of a numeric control machine in accordance with an illustrative embodiment;

FIG. 12 is an illustration of a flowchart of a process for creating a numeric control code in accordance with an illustrative embodiment;

FIG. 13 is an illustration of a flowchart of a process for creating volumetric representations in accordance with an illustrative embodiment;

FIG. 14 is an illustration of a flowchart of a process for manufacturing a part in accordance with an illustrative embodiment;

FIG. 15 is an illustration of a flowchart of a process for manufacturing a part in accordance with an illustrative embodiment;

FIG. 16 is an illustration of a block diagram of a data processing system in accordance with an illustrative embodiment;

FIG. 17 is an illustration of a block diagram of an aircraft manufacturing and service method in accordance with an illustrative embodiment;

FIG. 18 is an illustration of a block diagram of an aircraft in which an illustrative embodiment may be implemented; and

FIG. 19 is an illustration of a block diagram of a product management system in accordance with an illustrative embodiment.

### DETAILED DESCRIPTION

The illustrative embodiments recognize and take into account one or more different considerations as described herein. Illustrative examples recognize and take into account that current processes for manufacturing parts are cumbersome and complex requiring use of many different programs and systems in the process of manufacturing parts from three-dimensional designs of the parts. For example, time and effort from production engineers are used to build and design parametric models, seed models, wizards and associative templates relative to part families and similar design geometries for machining processes. For example, complexities and time of production engineers is used in adapting tool path trajectories to various geometries across a spectrum of CAD systems and formats.

Current systems are unable to automatically define details such as tool path algorithms and machine parameters used to operate CAM systems to machining processes for manufacturing parts. The tool path processes and machining parameters are currently created by a manufacturing engineer or programmer.

The illustrative examples can avoid these issues through the use of volume based machining tool path algorithms focused on triangle mesh rather than surface specific tool path algorithms and a knowledge based selection of cutting tools and parameters.

Thus, illustrative examples provide increased efficiency in manufacturing parts by standardizing three-dimensional models such as CAD models using volumetric representations. In one illustrative example, this step standardizes the input of CAD models by triangulating the models’ surfaces into volumetric representations such that various format standards of CAM systems can be evaluated the same without the need of parametric modeling or surfacing solutions.

For example, the inputs to automate complete machining processes include a part, stock, fixture as objects. A number of split surfaces can also be input for use in machining operations to formal departs. The part represents a three-dimensional model of the final design to manufacture. The stock represents the starting material in a raw state. The fixture represents the work holding features such as fixturing along with integrated solutions such as tabs. The spilt surface represents the height to which the machining process should progress to. With these volumetric representations, the objective examples can apply the objects as standard inputs to a generic set of machining tool path algorithms such as roughing, rest roughing, walls, floor and rest finishing.

Additionally, the illustrative examples can evaluate the volumetric representations to extract the information required that are variables dependent on the three-dimensional models such as stock height and spilt surfaces height relative to a machining direction and local coordinates in a Z direction.

In another illustrative example, workflow manager 214 establishes machining parameters such as a ratio of depth to width required for material stability during the machining process. For example, machining aluminum requires a 4:1 ratio depth to width to maintain stability. The ratio is applied to the roughing and rest roughing automatic tool path operations as an offset of stock to leave during machining from the final part. This ensures that the stock is stable during machining processes. The cutting tools filter selects the optimal cutting tools and establishes stable cutting tool conditions for each of the generic set of machining tool path algorithms such as roughing, rest roughing, walls, floor and rest finishing.

Further, illustrative examples identify a sequential set of generic tool path algorithms that will each perform a specific task to produce a rapid manufactured part. This operation can be used to identify the machining processes needed to manufacture the part. For example, with a simple 3-axis aerospace part, the sequential pattern of sequences may require four tool path operations with various diameters and types such as follows: 1) Roughing with a Bull Nose tool, 2) Rest Roughing with a Bull Nose tool, 3) Finish Flat areas, Bull Nose tool, 4) Finish Walls, Bull Nose tool, 5) Rest Finish with a Bull Nose tool. Simple 3-axis parts can be standardized to follow this pattern of sequential operations to automatically create complete machining processes for three-dimensional model based engineering for rapid manufacturing processes.

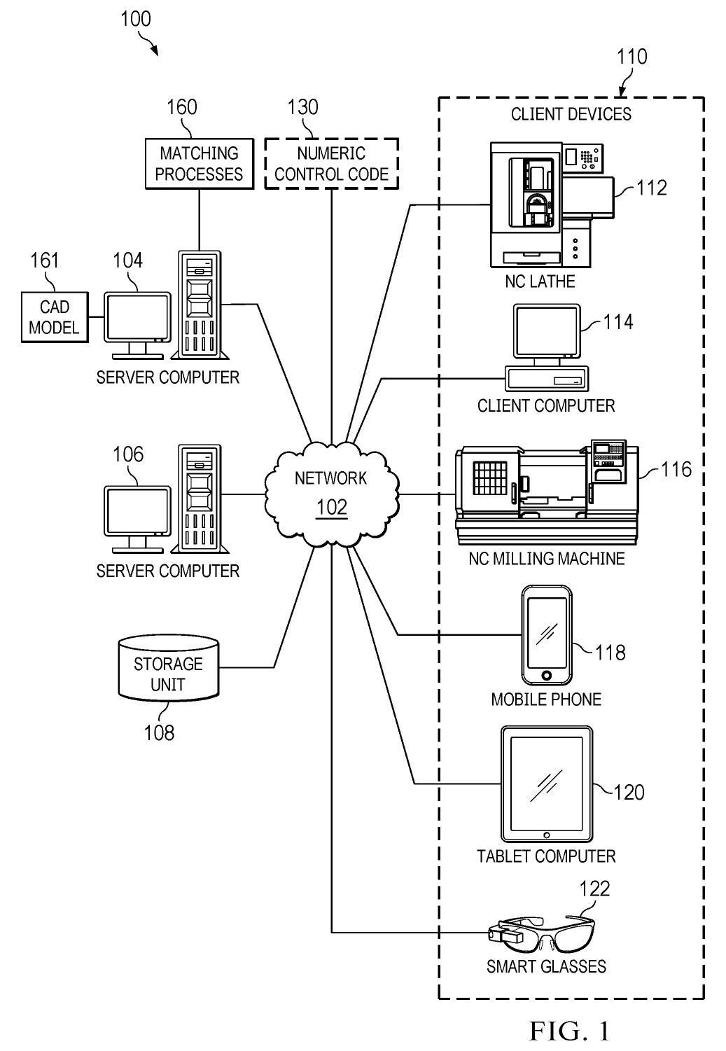

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. Client devices 110 can be, for example, computers, workstations, network computers, vehicles, machinery, appliances, or other devices that can process data. As depicted, client devices 110 include numeric control (NC) lathe 112, client computer 114, numeric control (NC) milling machine 116, mobile phone 118, tablet computer 120, and smart glasses 122. Client devices 110 can be, for example, computers, workstations, network computers, numeric control machines, or other machines or objects that include processing resources that can run program code. In the depicted example, server computer 104 provides information, such as boot files, operating system images, and applications to client devices 110.

Further, in this illustrative example, server computer 104, server computer 106, storage unit 108, and client devices 110 are network devices that connect to network 102 in which network 102 is the communications media for these network devices. Some or all of client devices 110 may form an Internet of Things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In the depicted example, server computer 104 provides information, such as boot files, operating system images, and applications to client devices 110. For example, server computer 104 generates information in the form of numeric control code 130 that can be sent to NC lathe 112 and NC milling machine 116. Numeric control code 130 is run by these numeric control machines to manufacture workpieces.

For example, NC lathe 112 can manufacture a part by rotating a stock while moving a cutting tool against the stock to remove material to form a part using numeric control code 130.

As another example, NC milling machine 116 can run numeric control code 130 to remove material from stock or a blank in which cutting tools moves along paths in multiple axes. This type of machine can perform drilling, milling, chamfering, contouring, and other operations to form various workpieces such as aircraft parts. For example, these aircraft parts include at least one of a wing rib, a fuselage panel, a wear plate, a hex lock support, a housing, and an engine mount.

In the illustrative examples, numeric control code 130 is generated more efficiently and with less effort as compared to current processes. In these illustrative examples, machining processes 160 are automatically created by server computer 104 in response to selecting the part. These machining processes are generated using a three-dimensional model based engineering design of the part to be manufactured. In this example, this design is computer aided design (CAD) model 161.

Server computer 104 also identifies other information for creating machining processes 160. This information can include a selection of tools, process parameters, the sequence of machining operations, and other information. This information is used to generate machining processes 160. These processes are generic to particular numeric control machines.

Further, the illustrative examples use generic tool path processes that are based on triangle meshes for volumetric representations of the parts, stock, and fixtures. These types of meshes for the volumetric representations are used in contrast to current techniques that focus on surface specific tool path algorithms.

Server computer 104 then uses machining processes 160 to create numeric control code 130 for a specific numeric control machine. For example, numeric control code 130 can be generated specifically to run on NC lathe 112 or NC milling machine 116 from machining processes 160. For example, numeric control code 130 is specific to a manufacturing model of NC lathe 112 or NC milling machine 116.

In the depicted example, network data processing system 100 is the internet with network 102 representing a worldwide collection of networks and gateways that use the Transmission Control Protocol/Internet Protocol (TCP/IP) suite of protocols or other networking protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of” when used with reference to items means one or more items. For example, a number of different types of networks is one or more different types of networks.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In other illustrative examples, one or more other numeric control machines can be present in client devices 110 in addition to NC lathe 112 and NC milling machine 116. These other numeric control machines include plasma cutters, grinding machines, and other suitable types of numeric control machines used to manufacture parts.

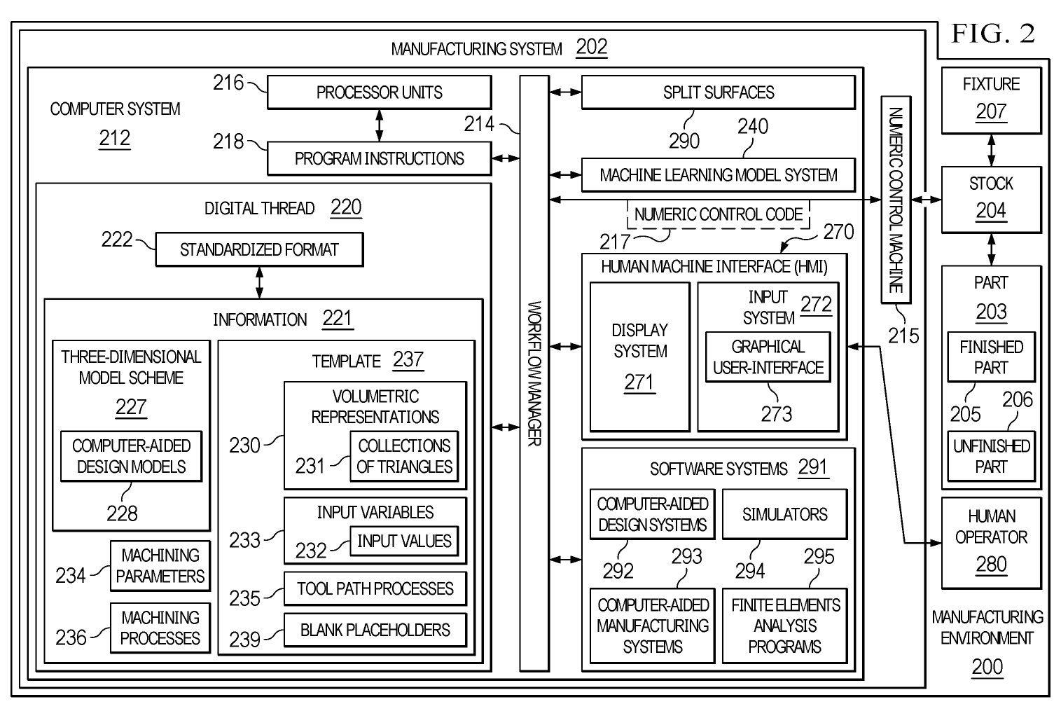

With reference now to FIG. 2, an illustration of a block diagram of a manufacturing environment is depicted in accordance with an illustrative embodiment. In this illustrative example, manufacturing environment 200 includes components that can be implemented in hardware such as the hardware shown in network data processing system 100 in FIG. 1.

In this example, manufacturing system 202 can operate to manufacture part 203. In this illustrative example, part 203 is a material or component that is processed to obtain a desired shape, structure, or function. Part 203 can be finished part 205 or unfinished part 206. Finished part 205 is a fully finished component that is ready for use. In other examples, part 203 is unfinished part 206, which is a partially finished component that needs further processing to form finished part 205. Unfinished part 206 can be, for example, a partially machined blank or other components that are further processed to generate finished part 205.

In this illustrative example, manufacturing system 202 includes a number of different components. As depicted, manufacturing system 202 comprises computer system 212, workflow manager 214, numeric control machine 215, and digital thread 220. Workflow manager 214 is located in computer system 212.

Workflow manager 214 can be implemented in software, hardware, firmware or a combination thereof. When software is used, the operations performed by workflow manager 214 can be implemented in program instructions configured to run on hardware, such as a processor unit. When firmware is used, the operations performed by workflow manager 214 can be implemented in program instructions and data and stored in persistent memory to run on a processor unit. When hardware is employed, the hardware can include circuits that operate to perform the operations in workflow manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

Numeric control machine 215 is a hardware system that also includes software. Numeric control machine 215 can be selected from a group comprising a two dimensional numeric control machine, a three dimensional numeric control machine, a milling machine, a grinding machine, a lathe, a plasma cutter, a laser cutter, a water jet cutter, and suitable numeric control machines. This machine operates to manufacture part 203. Numeric control machine 215 can be any computer-controlled machine that uses a software program to automate the manufacturing of part 203. In this example, numeric control machine 215 uses numeric control code 217 to perform manufacturing operations on stock 204 held by fixture 207 to form part 203 without needing guidance from human operator 280.

In this illustrative example, stock 204 is a raw material from which part 203 is machined. This stock is an initial workplace that can be cut, milled, drilled, or otherwise shaped into part 203. This stock can also be referred to as a blank.

Fixture 207 is a work holding device used to at least one of position, support, or stabilize stock 204 during machining operations to form part 203. In some examples, this fixture is component such as a base for tabs that are left temporally on stock 204 as part of fixture 207.

In this illustrative example, numeric control code 217 comprises program instructions that are for use by numeric control machine 215 to provide instructions to manufacture part 203. These instructions provided by numeric control code 217 can include at least one of a machine movement for a cutting tool, a machine movement for a workpiece, a feed rate, or other operations related to manufacturing part 203.

In this illustrative example, numeric control code 217 can be geometric code (G-code) that specifies the different movements of components in numeric control machine 215 to manufacture part 203. In this example, G-code is defined by ISO 6983, which is an international standard defining programming language and data format used by numeric control machines. These movements can define paths of the tool used to manufacture part 203.

In other examples, numeric control code 217 can take other forms or formats in addition to G-code that provide instructions to control the operation of numeric control machine 215 to manufacture part 203. For example, other forms of numeric control code 217 can be selected from at least one of a script, programmable logic controller (PLC) code, extensible markup language (XLM) proprietary machine code, or other types of program code.

In this illustrative example, information 221 used by workflow manager 214 can be in standardized format 222. Information 221 used by workflow manager 214 can be stored in digital thread 220, which is a connected flow of data that provides information for part 203. In other examples, information 221 can be stored in a database or other structure. In these examples, if workflow manager 214 receives information that is not in standardized format 222, this information can be converted to form information 221 in standardized format 222.

In this illustrative example, workflow manager 214 receives a selection of part 203 for manufacturing. With the identification of part 203, workflow manager 214 identifies three-dimensional model scheme 227 as information 221 for part 203. This schema comprises a number of computer-aided design models 228 for part 203, stock 204, and fixture 207. In some illustrative examples, part 203, stock 204, and fixture 207 each have a computer-aided design model. In other examples, all three of these components may be found in a single computer-aided design model. In yet other illustrative examples, part 203 may be in one computer-aided design model and stock 204 and fixture 207 can be in another computer-aided design model. In yet another illustrative example, part 203 and stock 204 can be in one computer-aided design model while fixture 207 is in another computer-aided design model.

In this example, workflow manager 214 creates volumetric representations 230 for three-dimensional model scheme 227 of part 203, stock 204, and fixture 207 for holding part 203. Creating volumetric representations 230 of these components, provides standardization of the models for part 203, stock 204, and fixture 207. With the use of volumetric representations 230, the need for parametric modeling or surfacing solutions becomes unnecessary.

These volumetric representations can be collections of triangles 231 for surfaces of part 203, stock 204, and fixture 207. These volumetric representations are saved in standardized format 222 for further standardization.

Workflow manager 214 determines input values 232 for input variables 233 used for planning a machining of the part 203. These input variable describe values for the objects represented by volumetric representations 230 as well as the positioning or relationship between these objects. For example, input values 232 for input variables 233 can be used to describe dimensions and other features of volumetric representations 230 for at least one of part 203, stock 204, and fixture 207.

Other objects that are involved in machining stock 204 to form part 203 can also be in volumetric representations 230. These other objects can have input values 232 for input variables 233.

For example, volumetric representations 230 can also be present for a number of split surfaces 290. A split surface is a machining boundary or parting surface that can be used to separate different machining operations or assistant part fixturing. The surface can be a flat control surface that serves as a reference machining processes and can be useful for multi-axis machine, to access, or part orientation.

In one example, a spilt surface is given a computer-aided design feature surface that is created to establish, prevent or stop the tool path algorithm from machining any deeper from one side of the part. This type of surface can be used can used as a volumetric tool path operation that functions as a control or determines what is side one verse aside to control or determine side 1 versus side 2 “flipped” directions.

In this illustrative example, examples of input variables 233 for which input values 232 can be determined include at least one of a ratio of depth to width (often referred to as the aspect ratio of the cut) is an input variable that is a factor in ensuring material stability during machining. This ratio influences cutting forces, a tool deflection, material deformation, and the risk of chatter or vibration. Other input variables include, for example, a surface clearance, a split surface clearance, a surface offset, a split surface offset, a stock height, a number of levels, a ratio depth to width, a maximum pocket width, a minimum pocket width, a smallest corner radius, a smallest fillet radius, a clearance, a cutting speed, a feed rate, a cutting depth, a cutting width, a spindle speed for a cutting tool, a tool geometry, an offset, a pattern type, a lowest cut level offset, a fixture clearance, a minimum thickness, a stock to leave, or other suitable input variables.

In these illustrative examples, input variables 233 are preselected based on a number of factors including at least one of machine kinematics, material, distortion simulation, part specific meta features, part specific geometric dimensioning and tolerances, cutting tools, cutting parameters, or other factors. These input variables can change from part to part. Further the selection of which input variable to use can change with different numeric control machines use to machine the same part.

With respect to determining input values 232 for input variables 233, input values 232 for some input variables can be a computer aided design model (CAD) model. For example, an input value for a part offset can be identified simulation results obtained from performing finite element analysis simulations or machining a part using a specific type of numeric control machine. In another example, an analysis performed of the computer-aided design model in a computer-aided design system can use a standard format such as STEP can be used to identify input values 232 for input variables 233 relating to features of part 203. In this example, this analysis can be controlled by workflow manager 214. These features can include at least one of a corner radii, a hole diameter, a pocket depth, surface curvature, or other features for part 203.

Workflow manager 214 can also control a computer aided manufacturing system to identify three-dimensional representations such as stock, fixture and part that are passed as industry standard STEP conversion tools to mesh STL files.

In the illustrative example, volumetric representations 230 can be evaluated to determine input values 232 for input variables 233. These input variables can be variables that depend on the design of part 203 in three-dimensional model scheme 227. These variables include those that describe part 203, stock 204, and fixture 207 in volumetric representations 230. These variables can also describe the number of split surfaces 290 when the number of split surfaces 290 is present in volumetric representations 230 for stock height and split surfaces relative to machining directions and local coordinates in the Z direction.

As part of planning machining for part 203, workflow manager 214 determines machining parameters 234 using volumetric representations 230 and input values 232 for input variables 233. In these examples, machining parameters 234 are variables that define conditions for processing a material such as stock 204 during machining operations to form part 203. These machining parameters can define how a cutting tool interacts with stock 204 during machining to form part 203.

For example, these machining parameters can be used to determine the tool path, cutting conditions, and material removal characteristics to achieve the desired geometry, surface finish, and machining efficiency. These parameters can influence factors such as tool engagement, material removal rate, machining forces, heat generation, and tool wear, ensuring optimal performance and precision in the machining process to form part 203 from stock 204. These machining parameters can include at least one of a maximum tilt angle, an axial offset, a minimum width, a maximum step over, a keller finish, a depth step, a cusp height, a stepover, a depth of cut, a link motion, a tolerance, a machine control statement, or other suitable parameters.

Next, workflow manager 214 creates tool path processes 235 using machining parameters 234 and volumetric representations 405. These machining parameters can be used to create tool path processes 235 by identifying tool path processes 235 from a library or collection of tool path processes that can be used for manufacturing parts. The library or collection of tool path processes can be those used by or found in computer-aided manufacturing (CAM) systems. These tool path processes are also referred to as tool path algorithms. These tool path processes are volume-based tool path processes that are available in currently used computer-aided Manufacturing (CAM) systems.

In these examples, identification of tool path processes 235 by workflow manager 214 can be made by performing filtering of a collection of tool path processes to identify which of these tool path processes in the collection are needed for tool path processes 235 for use in manufacturing part 203. This filtering can be referred to as tool filtering.

In these illustrative examples, tool path processes 235 are generic and not specific to any particular numeric control machine. Tool path processes 235 can be executed in a programmatic way, meaning they are not fixed in place. These tool path processes can be at least one of moved or altered as needed. In other words, these tool path processes are not rigidly predefined and are more generic in form, enabling adjustments based on various conditions, part geometry, or other inputs. These tool path processes can be adjusted to optimize material removal, improve surface finish, or adapt to tool wear. This flexibility allows adjustments such as shifting the tool path to avoid collisions, altering step-over distances for efficiency, or modifying cutting directions based on material properties.

Workflow manager 214 can also perform this tool path filtering to refine and optimize the tool path data to eliminate unnecessary or excessive tool movements, reduce abrupt direction changes, and smooth trajectory transitions. Tool path filtering can be implemented by workflow manager 214 using filtering processes in computer-aided manufacturing (CAM) systems 293. These filtering processes can be used by workflow manager 214 through workflow manager 214 controlling the operation of the CAM system or performing this filtering outside of the CAM system. Workflow manager 214 can perform tool filtering to improve machining efficiency, minimize tool vibrations, and enhance surface finish by ensuring that the tool moves smoothly and consistently through the material while maintaining dimensional accuracy. With this filtering, workflow manager 214 creates tool path processes 235.

Thus, workflow manager 214 can interpret the metadata in standardized format 222 and information from 221 to programmatically configure software systems of 291. As example the workflow manager 214 can configure computer aided design (CAD) systems 292 and computer-aided manufacturing (CAM) systems 293 to dynamically assign information 221 such as tool path processes 235 by identifying who path processes needed for use in total path processes 235. Workflow manager 214 can then configure the template 237 to input volumetric representations 230 and configure input variables 233 and assign required tool path processes in tool path processes 235 using machining parameters 234 and machining process 236 to replace blank placeholders of 239. The workflow manager 214 can programmatically interface to share information 221 with software systems 291 such as computer aided manufacturing systems 293 to manufacture part 205.

For example, a tool path process 235 in the form of a drilling tool path algorithm may be used to select machining parameters 234 and assign input variables 233 to find a part 203 with a 0.250-inch diameter hole in present in computer-aided design model in computer-aided design models 228, and preprocess analysis of the computer-aided design model determines that machining process 236 can be executed in the manufacturing last setup and first tool path for computer-aided manufacturing (CAM) systems 293. Alternatively, the same drilling tool path algorithm can be used to find a 0.375-inch diameter hole that can be executed in the first setup and last path. The data can be adjusted for these examples as part of generating tool path processes 235.

Additionally, in some cases, a drilling operation may not be needed for a part. Tool path filtering can be performed by workflow manager 214 and determined when the use of the drilling algorithm is unnecessary. Not every part will require the same tool path algorithms. As a result, tool path filtering can be performed by workflow manager 214 to determine whether particular tool path algorithms are needed.

Tool path processes 235 can take a number of different forms. For example, tool path processes 235 can be three axis tool path algorithms or five axis tool path algorithms and can be implemented using tool path algorithms found in computer aided manufacturing systems (293). In this illustrative example, three axis tool path algorithms used for tool path processes 235 can be selected from at least one of roughing, rest roughing, finishing floors, finishing walls, rest finishing, hole making, or other types of three axis tool path algorithms. In this example, five axis tool path algorithms used for tool path processes 235 can be selected from at least one of muti-axis roughing, muti-axis rest roughing, muti-axis finishing floors, muti-axis finishing walls, muti-axis rest finishing, or other five axis tool path algorithms.

In one illustrative example, workflow manager 214 can create tool path processes 235 using machine learning model system 240. Machine learning model system 240 can be one or more machine learning models. In this example, workflow manager 214 identifies optimal tool path processes using machine learning model system 240 and machining parameters 234. These machining parameters are used as inputs into machine learning model system 240. In response, machine learning model system 240 outputs an identification of optimal tool path processes for tool path processes 235. In this example, a number of machine learning models in machine learning model system 240 has been trained using tool path processes along with results from prior machining of parts using those tool path processes.

Further, machine learning model system 240 can also be trained to predict machining processes 236 that are optimal for manufacturing part 203. In other words, machine learning model system 240 can output machining processes 236 that are optimal.

Workflow manager 214 creates machining processes 236 using tool path processes 235, volumetric representations 230, and input values 232 for the input variables 233. Machining processes 236 using tool path processes 235, volumetric representations 230, and input values for the input variables 233 can form template 237. In this example, the template is a form that has a number of blank placeholders 239 that are processed to be specific for part 203. In other words, some of input values 232 may need to be filled in for input variables 233. In these examples, blank placeholders 239 can be filled by machine learning model system 240 and are specific to part 203 that is to be manufactured.

Machining processes 236 are used to manufacture the part. In these examples, machining processes 236 are a generic form of numeric control code 217. In other words, machining processes 236 are not specific to any particular numeric control machine. These machining processes are generic to numeric control machines but created to be specific to the geometry of a particular part.

In these illustrative examples, information 221 is in standardized format 222. For example, volumetric representations 230 and input values 232 for input variables 233 are in a standardized format 222. Tool path processes 235, machining parameters 234, and machining processes 236 are in a standardized format 222.

Workflow manager 214 controls an operation of numeric control machine 215 to machine stock 204 to form part 203 using machining processes 236. For example, wherein in controlling the operation of numeric control machine 215, the workflow manager creates numeric control code 217 for numeric control machine 215 using machining processes 236.

Workflow manager 214 operates numeric control machine 215 using numeric control code 217 to manufacture part 203. In creating numeric control code 217, workflow manager 214 can convert machining processes 236 from a generic form to numeric control code 217 that is specific to numeric control machine 215. In one example, machining processes are in a generic form that can be text in *.clsf and is converted to geometric code (G-code) and machine code (M-code) specific to numeric control machine 215. G-code controls tool movement and positioning in the machining process. M-code controls parameters for numeric control machine 215 such as spindle direction, spindle speed, running on coolant, and other functions that are not specific to the movement of the tool along the path.

In this example, the standardized format can be a Standard for the Exchange of Product model data (STEP). This format can be used to generate STEP files such as STEP 238 or STEP 242. This format enables the exchange of three-dimensional model data between computer-aided design software that use different file formats.

In these illustrative examples, workflow manager 214 can perform different operations using a number of software systems 291. As depicted in this example, these software systems can include computer-aided design systems 292, computer-aided manufacturing systems 293, simulators 294, finite elements analysis programs 295, and other types of software systems.

Workflow manager 214 and controlling the use of software systems 291 without needing human intervention in performing different operations to create numeric control code 217 and use that numeric control code to machine part 203 from stock 204. In these examples this type of operation control of software systems 291 is enabled through the use of storing information 221 needed used by the systems and standardized format 222. With standardized format 222, information 221 needed by different systems can be converted from that format into the format used by particular system and software systems 291. As a result, different systems performing similar functions can be selected and used automatically by workflow manager 214.

For example, a Roughing Tool path process that is going based and be available in each type of computer-aided manufacturing system in computer-aided manufacturing systems 293. A computer-aided manufacturing system from a particular company will have a roughing tool path process that accomplishes Roughing canned cycle by simply inputting their “Roughing” tool path algorithm so computer-aided manufacturing system can create a tool path process for their specific host system to use. Workflow manager 214 obtains information 221 such as machining parameters 234 and volumetric representations 230 stored in and converts that information to format that can be sent to a computer-aided manufacturing system in computer-aided manufacturing system 293. For example, this format can be a format for which the computer-aided manufacturing system receives information through application programming interfaces (APIs).

As another example, volumetric base tool path process are available in computer-aided manufacturing systems 293, but these systems has standard to interchange the data for volumetric representations 230. With this example, specific Host System API protocols for a system such as a computer-aided design system is replicated to interact with specific CAM variables in a computer-aided manufacturing system.

For example, with a volumetric representation, a set of objects in a computer-aided design system is selected for use as inputs into a computer-aided manufacturing system. These objects can be stored in standardized format 222 and then converted into the format expected as inputs by the computer-aided manufacturing system.

Each computer-aided design and computer-aided manufacturing system can utilize their functions to model and read from information 221 in standardized format 222 such as STEP to describe those representations in their system. Each computer-aided manufacturing system may have an interfaces, such as APIs, using a different standards to identify those objects in their own specific CAM functions. In these examples, workflow manager 214 can include functionality to take objects, such as volumetric representations 230, and variables, such as input variables 233, in standard format 222 and convert that information into a format expected by interfaces, such as APIs, to perform operations in these examples.

Other conversions of information 221 from standardized format 222 can be made to send information to other software systems in software systems 291 to use those software systems to perform the different operations in these examples. Thus, workflow manager 214 can perform different operations using software systems 291 when those software systems already include features or functions to perform the desired operations, reducing the need to create custom software for performing operations.

In this illustrative example, human machine interface (HMI) 270 is an interface system that can be used by human operator 280 to interact with different components in computer system 212. This interface can be located on the same computing device or a different computing device from workflow manager 214 in computer system 212. As depicted, human machine interface 270 comprises display system 271 and input system 272.

Display system 271 is a physical hardware system and includes one or more display devices on which graphical user interface 273 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

Human operator 280 is a person that can interact with graphical user interface 273 through user input generated by input system 272 for computer system 212. Input system 272 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device.

In this example, human operator 280 can use human machine interface 270 to select part 203 for manufacturing using manufacturing system 202. Further, human operator 280 can also view and analyze information within digital thread 220 using human machine interface 270. For example, human operator 280 can at least one of view volumetric representations 230 created from three-dimensional model scheme 227, view template 237, quote information, or electronic shop documentation to manufacture part 203. In one example, workflow manager 214 can display simulations for machining part 203 on human machine interface 270. Workflow manager 214 can also display volumetric representations 230 on human machine interface 270.

In one illustrative example, one or more technical solutions are present that overcome a technical problem with the amount of time and effort needed to manufacture parts using three-dimensional models. As a result, one or more technical solutions may provide a technical effect automating the manner in which parts can be manufactured from models. For example, one or more illustrative examples use volumetric representations to standardize the representation of models for parts, stock, and fixtures. This standardization can reduce or make unnecessary the need for parametric modeling or surfacing solutions becomes unnecessary. As a result, at least one of time, complexity, or cost for manufacturing parts from three-dimensional models such as computer-aided design models can be reduced.

Computer system 212 can be configured to perform at least one of the steps, operations, or actions described in the different illustrative examples using software, hardware, firmware or a combination thereof. As a result, computer system 212 operates as a special purpose computer system in which workflow manager 214 in computer system 212 enables manufacturing parts from numeric control code being generated from three-dimensional models of the parts. In particular, workflow manager 214 performs operations that have a practical application in manufacturing parts. The numeric control code generated in many different examples can be used to operate numeric control machines to manufacture parts. Thus, computer system 212 is transformed into a special purpose computer system as compared to currently available general computer systems that do not have workflow manager 214.

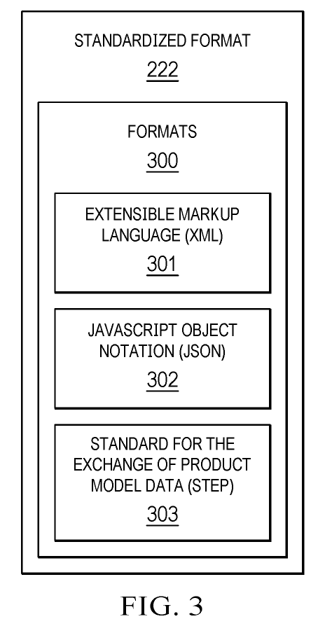

Turning next to FIG. 3, an illustration of a block diagram of a standardized format is depicted in accordance with an illustrative embodiment. In the illustrative examples, the same reference numeral may be used in more than one figure. This reuse of a reference numeral in different figures represents the same element in the different figures.

In this illustrative example, an example of an implementation for standardized format 222 for information 221 in FIG. 2 is shown. As depicted, standardized format 222 can be comprised of a number of formats 300 used for standardizing information 221. For example, formats 300 in standardized format 222 can include Extendable Markup Language (XML) 301, JavaScript Object Notation (JSON) 302 and Standard for the Exchange of Product model data (STEP) 303. Standard for the Exchange of Product model data (STEP) 303 can be used to generate STEP files such as STEP 238 or STEP 242. This format is in standardized format 222.

In this illustrative example, Extendable Markup Language (XML) 301 is a structured, text-based format used for storing, transporting, and organizing data in a hierarchical manner. This format defines data using custom tags that describe the content, making it both human-readable and machine-parsable. In the depicted examples, information such as volumetric representations 230 and input variables 233 can be stored in Extensible Markup Language (XML) 301

JavaScript Object Notation (JSON) 302 is a text based data interchange format in which data can be represented as key-value pairs, arrays, or nested structures. This type of standard can be used to store machining parameters 234 and tool path processes 235.

Standard for the Exchange of Product model data (STEP) 303 is defined using ISO 10303. This format can be used to store models such as computer-aided design (CAD) models 228 in three-dimensional model scheme 227 as in other models.

With formats 300 in standardized format 222, information stored in formats 300 can be converted into formats used by particular systems selected from at least one of a simulator, a computer-aided model system, a computer-aided manufacturing system, a maintenance planning system, a lifecycle management system, an enterprise resource planning (ERP) system, or other systems in which these different systems use different formats for receiving and using information.

Formats 300 depicted in standardized format 222 in this figure is presented as an example of a standardized format and not meant to limit the manner in which standardized format 222 can be implemented in other examples. For example, Universal Modeling Language (UML), Drawing Exchange Format (DXF), Extensible 3D (X3D) can be used in place of or in addition to formats 300.

The illustrative examples provide a method, apparatus, system, and computer program product that enables automated generation of numeric control code for manufacturing parts from computer-aided design models of those parts. In illustrative examples, volumetric representations are used. This approach avoids the need for a parametric design or feature recognition concepts as using current techniques. Further, the illustrative examples use volumetric representations such a triangular mesh for the surface of objects such as parts, stock, and fixtures.

In the illustrative example, tool path processes are volume based, flexible and can adapt to any 3d model design while automatically selecting machining parameters for stable quality rapid manufacturing processes. This is in contrast to current techniques that require user knowledge and input for surface based tool path algorithms or require parametric design concepts or feature recognition with manual integration of the model ahead of time or incorporating into the early design phases.

The illustration of manufacturing environment 200 and different components in FIGS. 2-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, information 221 is shown as being stored in digital thread 220. In other illustrative examples, information 221 can be stored in other locations such as a database, an object storage, a hierarchical file system, and other types of storage.

In yet another example, simulations for machining processes 236 are performed as part of the process for manufacturing part 203. The simulations can also be viewed by human operator 280 on display system 271 in human machine interface 270.

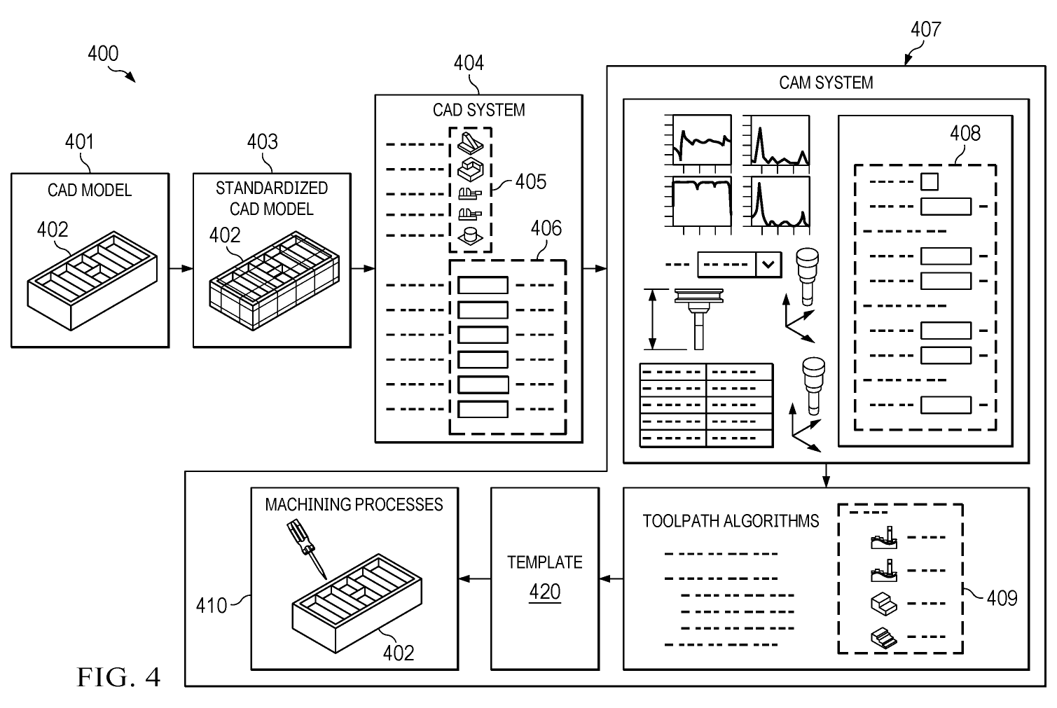

Next in FIG. 4, an illustration of a process flow for manufacturing a physical part is depicted in accordance with an illustrative embodiment. In this example, process flow 400 can be used to machine stock 204 to form part 203 in FIG. 2. This process can be performed using workflow manager 214 in manufacturing system 202 in FIG. 2.

In this example, information generated as part of this process flow is in a standardized format and can be stored in a digital thread. Further, other information such as models that are selected for use or job information from other sources can be saved in the standardized format in the digital thread.

As depicted, computer-aided design (CAD) model 401 is an example of a three-dimensional model that can be selected for use in manufacturing parts. In this example, CAD model 401 is a design for part 402. CAD model 401 is converted into a standardized format to form standardized CAD model 403 for part 402. This standardized CAD model 403 is an example of a model in computer-aided design models 228 in FIG. 2. This model is input into computer-aided design (CAD) system 404. In this example, volumetric representations 405 and input values for input variables 406 are generated in CAD system 404. Volumetric representations 405 and input values for input variables 406 are examples of volumetric representations 230 and input values 232 for input variables 233 in FIG. 2.

The generation of this information is controlled by the workflow manager. Workflow manager 214 can generate commands and queries to CAD system 404 to generate volumetric representations 405 and input values for input variables 406. The generation of volumetric representations 405 can be formed using tessellation or meshing process that can be implemented in CAD system 404. In other examples, this process can be implemented outside of CAD system 404.

Volumetric representations 405 and input values for input variables 406 is input into computer-aided manufacturing (CAM) system 407 under the control of the workflow manager. In this example, CAM system 407 processes this input to obtain machining parameters 408.

In this example, these machining parameters are used to generate tool path algorithms 409, which are an example of tool path processes 235 in FIG. 2. In this example, these tool path algorithms are a sequential set of generic tool path algorithms. Tool path algorithms 409 are generic and in a particular order for machining a stock to form a part. However, these tool paths are generic because they are not for a specific part.

In this example, tool path algorithms 409, volumetric representations 405, and input values for input variables 406 form template 420.

In this example, tool path algorithms 409 are used to generate machining processes 410 that are for machining a stock to form part 402. The generation of machining processes 410 also includes using volumetric representations 405 and input values for input variables 406. These machining processes are an example of machining processes 236. Machining processes 410 are numeric control code in a generic form that is not specific to a particular numeric control machine. This code may be a centerline source that can be used to create numeric control code that is specific for the particular numeric control machine that is used to manufacture part 402.

Machining processes 410 can then be converted into numeric control code that is specific for a numeric control machine that machines a stock to form part 402. In this illustrative example, the generation of machining parameters 408, tool path algorithms 409, template 420, machining processes 410, and numeric control code 411 can be performed using CAM system 407. These operations can be performed by the workflow manager controlling the operation of CAM system 407.

The illustration of process flow 400 is presented as an illustrative example and not meant to limit the manner in which other illustrative examples can be implemented. For example, in other illustrative examples, the different operations performed by CAD system 404 and CAM system 407 can be implemented in the workflow manager or a program controlled by the workflow manager that incorporates the processes for generating the different information without needing to use CAD system 404 and CAM system 407.

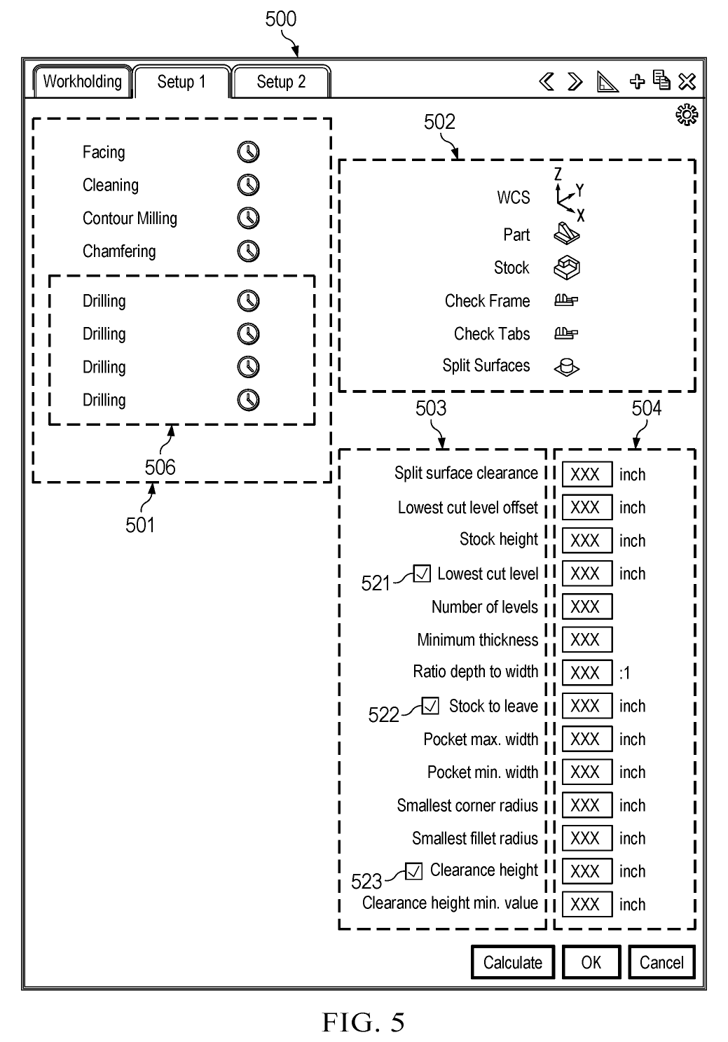

Next in FIG. 5, an illustration of a template is depicted in accordance with an illustrative environment. In this example, template 500 is an example of an implementation for template 237 in FIG. 2, and template 420 in FIG. 4 displayed in graphical user interface 273 in display system 271 of human machine interface 270. Template 500 is in an extensible markup language format.

As depicted in this illustrative example, template 500 is a blank template in which a part has not yet been selected for processing. In this example, the template can be for a particular numeric code machine. In this example, tool path processes 501, volumetric representations 502, and input values 503 for input variables 504 are in template 500.

As depicted in this example, volumetric representations 502 are for the part, stock, and fixture. Volumetric representations for the part also includes a split surface with a part. a split surface is surface on the stock material where the part is divided or separated during machining. This division can be used to optimize tool access, reduce material waste, or facilitate multi-axis operations. This split surface may be intentionally created as a machining reference, a parting line for multi-stage processing, or a separation plane for dividing large workpieces into smaller sections. The selection and placement of the split surface can impact tool path planning, fixture design, and machining efficiency, ensuring proper alignment and minimal material distortion during the manufacturing process. [

In this example, the tool path processes are shown in a sequential order. Further, blank placeholders 506 are present for later tool processes in the sequence of tool path processes 501. These blank placeholders are present . Allow for the input of different computer-aided design models for objects such as different parts, stock, and fixtures.

In this illustrative example, manual overrides for user input can be present for some input values. For example, checkbox 521 is present for lowest cut level, checkbox 522 is present for stock to leave, checkbox 523 this present for clearance height.

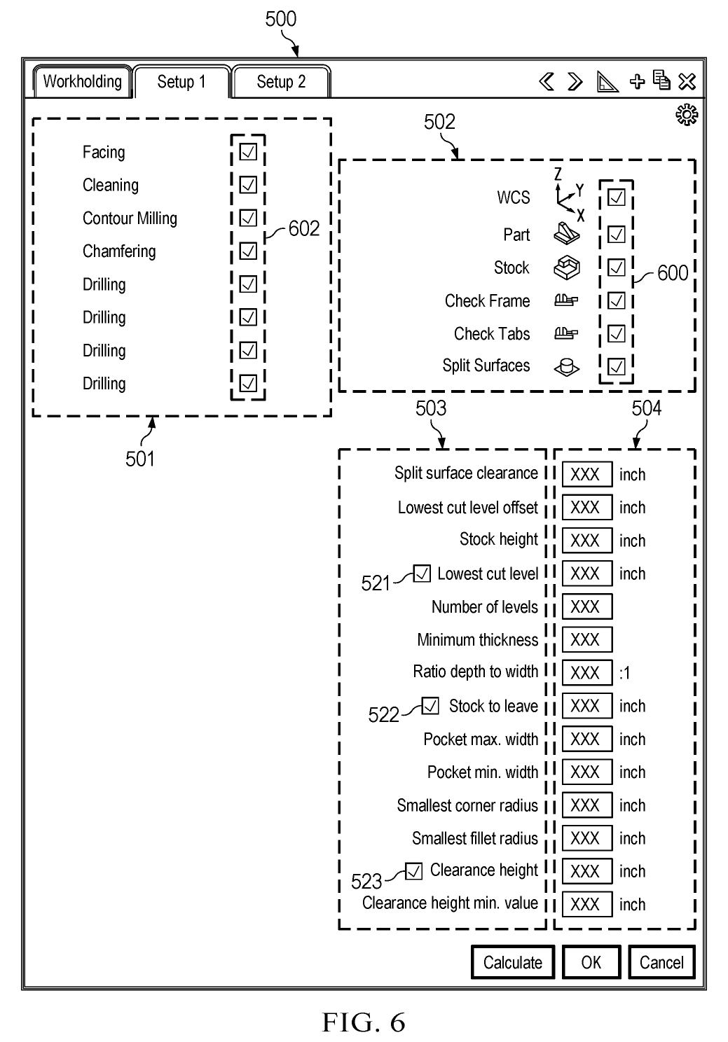

With reference to FIG. 6, an illustration of a completed template is depicted in accordance with an illustrative embodiment. In this illustrative example, template 500 is now any filled form in response to selecting a part, a stock, and a fixture. In this example, the selection results in volumetric representations being loaded as depicted by checkmarks 600.

With the identification of these volumetric representations, the blank placeholders are filled as indicated by checkmarks 602. These checkmarks These check marks represent tool paths that have been executed to the CAD objects. In these examples, the computer-aided design objects can be volumetric representations of the part, stock, fixture frame, fixture tabs, and split surfaces. Once the volumetric representation for a particular object is present in the blank placeholders and a tool path process has been generated, a checkmark is present for that for path process. Once complete, the output is in the form of tool path process and each of those processes are indicated as present with a checkmark.

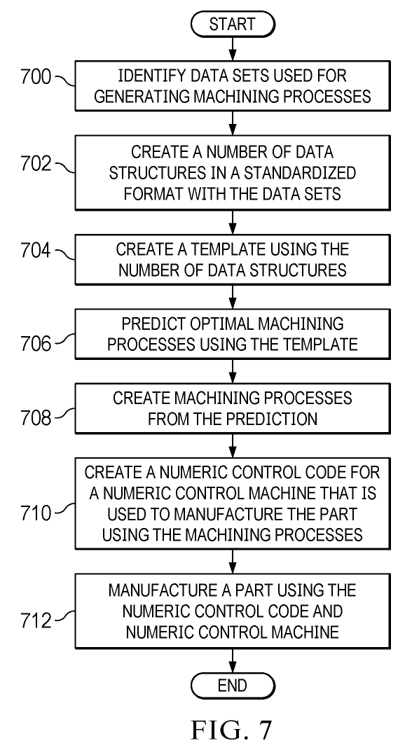

Turning now to FIG. 7, an illustration of a flow path for manufacturing a part is depicted in accordance with an illustrative embodiment. This flow path can be implemented using workflow manager 214 in FIG. 2.

In this example, the process identifies data sets used for generating machining processes (operation 700). In this example, the data sets include volumetric representations of the part to be manufactured, a stock to be machined to form the part, and a fixture that holds the stock. In this example, these volumetric representations can be created from a three-dimensional model scheme using one or more computer aided design models for these components. The three-dimensional model scheme can be identified based on the selection of the part to be manufactured. This three-dimensional model scheme can be located in at least one of a database, a digital thread, or other location. These data sets also include input values for input variables.

The process creates a number of data structures in a standardized format with the data sets (operation 702). In this example, the standardized format can be Extensible Markup Language 301 in FIG. 3.

The process creates a template using the number of data structures (operation 704). In operation 704, this template includes the volumetric representations, input values for input variables, and tool path processes. This information is included in the template and stored in a standardized format such as JavaScript Object Notation (JSON) 302 in FIG. 3.

The process predicts optimal machining processes using the template (operation 706). In operation 706, the prediction of the optimal machining process can be performed using a machine learning model. This machine learning model can be trained to predict the optimal machining processes using historical data for previously used machining processes and the results of inspecting parts created from these machining processes. The results can include test results from inspecting the finished parts and a comparison of these parts to tolerances for the parts. For example, the training data set for machining a bulkhead can include machine processes and test results for finished bulkheads and tolerances for the bulkheads.

In these examples, the output from the machine learning model can be configuration files identifying the machining processes and setup information that are used by the software the numeric control machine. This information setup information includes values for variables use by the machining processes such as stock orientation, clamping force, tool clearance, fixture offsets, reference surface and edges for alignment and other information used with machining the stock with the tool paths and operation defined in the machining processes.

The process creates machining processes from the prediction (operation 708). In operation 708, machining processes are created from the predictions. In this operation, the numeric control code in generic form is created based on the predictions of the optimal machining processes.

The process creates a numeric control code for a numeric control machine that is used to manufacture the part using the machining processes (operation 710). The process manufactures a part using the numeric control code and numeric control machine (operation 712). The process terminates thereafter.

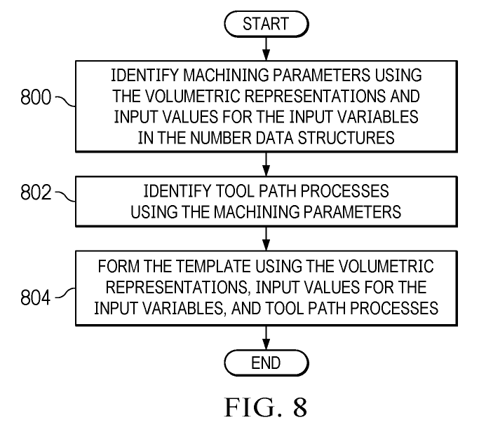

With reference text to FIG. 8, an illustration of a flow path for creating a template using a number of data structures is depicted in accordance with an illustrative embodiment. This flow path is an example of an implementation for operation 704 in FIG. 6.

The process identifies machining parameters using the volumetric representations and input values for the input variables in the number data structures (operation 800). The process identifies tool path processes using the machining parameters and the volumetric representations (operation 802).

The process forms the template using the volumetric representations, input values for the input variables, and tool path processes (operation 804). The process terminates thereafter.

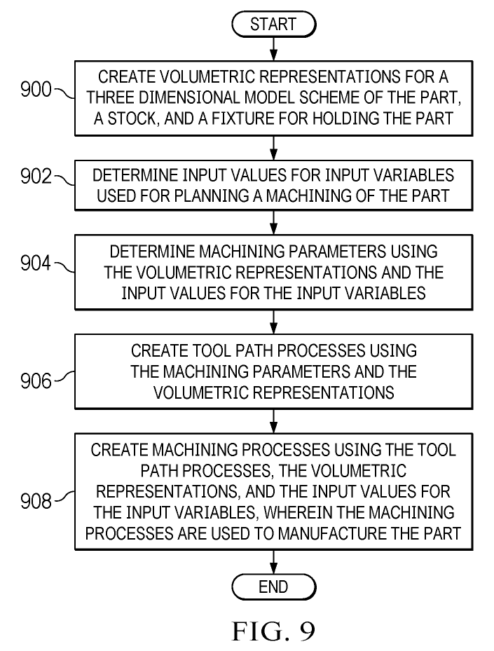

Turning next to FIG. 9, an illustration of a flowchart of a process for manufacturing a part is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in workflow manager 214 in computer system 212 in FIG. 2.

The process creates volumetric representations for a three dimensional model scheme of the part, a stock, and a fixture for holding the part (operation 900). The process determines input values for input variables used for planning a machining of the part (operation 902). The process determines machining parameters using the volumetric representations and the input values for the input variables (operation 904).

The process creates tool path processes using the machining parameters and the volumetric representations (operation 906). The process creates machining processes using the tool path processes, the volumetric representations, and the input values for the input variables, wherein the machining processes are used to manufacture the part (operation 908). The process terminates thereafter.

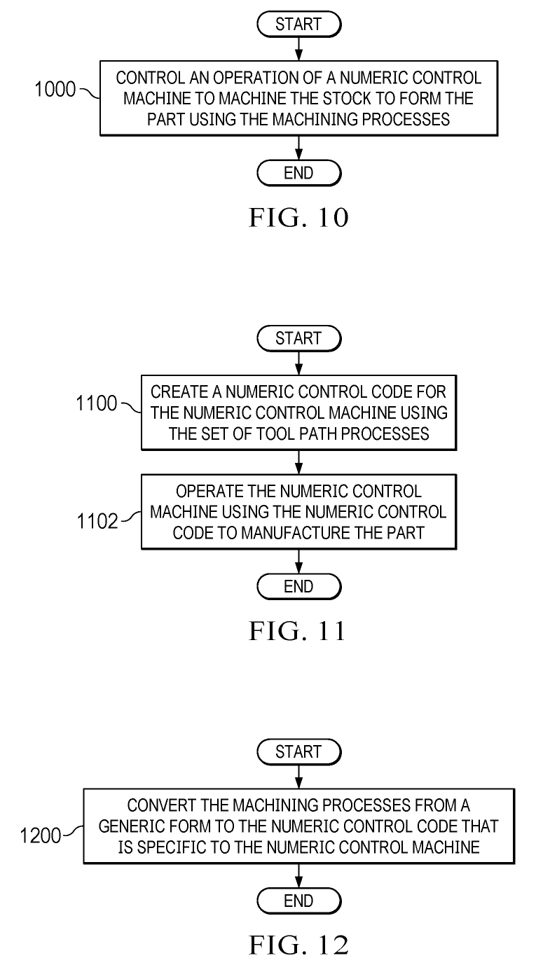

With reference now to FIG. 10, an illustration of a flowchart of a process for manufacturing a part is depicted in accordance with an illustrative embodiment. The process in this flowchart is an example of an additional operation that can be performed with the operations in FIG. 9.

The process controls an operation of a numeric control machine to machine the stock to form the part using the machining processes (operation 1000). The process terminates thereafter.

Next, in FIG. 11, an illustration of a flowchart of a process for controlling an operation of a numeric control machine is depicted in accordance with an illustrative embodiment. The process in this flowchart is an example of an implementation for operation 1000 in FIG. 10.

The process creates a numeric control code for the numeric control machine using the set of tool path processes (operation 1100). The process operates the numeric control machine using the numeric control code to manufacture the part (operation 1102). The process terminates thereafter.

With reference to FIG. 12, an illustration of a flowchart of a process for creating a numeric control code is depicted in accordance with an illustrative embodiment. This flowchart is an example of an implementation of operation 1100 in FIG. 11.

The process converts the machining processes from a generic form to the numeric control code that is specific to the numeric control machine (operation 1200). The process terminates thereafter.

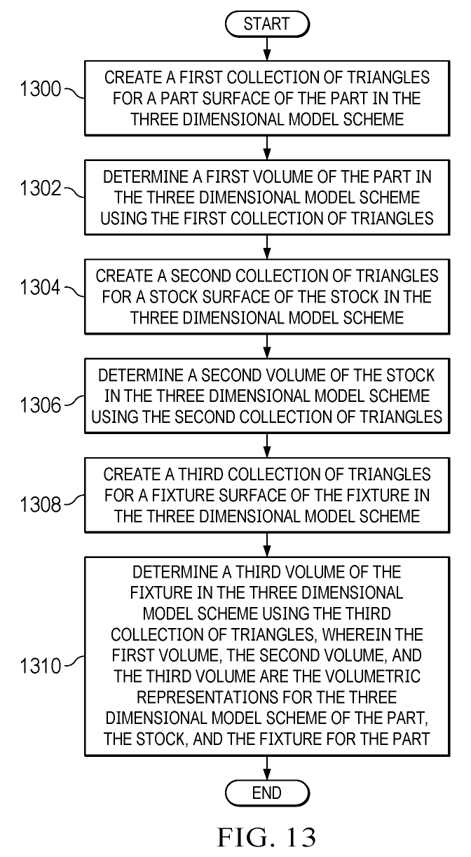

Turning to FIG. 13, an illustration of a flowchart of a process for creating volumetric representations is depicted in accordance with an illustrative embodiment. This flowchart is an example of an implementation for operation 900 in FIG. 9.

The process creates a first collection of triangles for a part surface of the part in the three dimensional model scheme (operation 1300). The process determines a first volume of the part in the three dimensional model scheme using the first collection of triangles (operation 1302).

The process creates a second collection of triangles for a stock surface of the stock in the three dimensional model scheme (operation 1304). The process determines a second volume of the stock in the three dimensional model scheme using the second collection of triangles (operation 1306).

The process creates a third collection of triangles for a fixture surface of the fixture in the three dimensional model scheme (operation 1308). The process determines a third volume of the fixture in the three dimensional model scheme using the third collection of triangles, wherein the first volume, the second volume, and the third volume are the volumetric representations for the three dimensional model scheme of the part, the stock, and the fixture for the part (operation 1310). The process terminates thereafter.

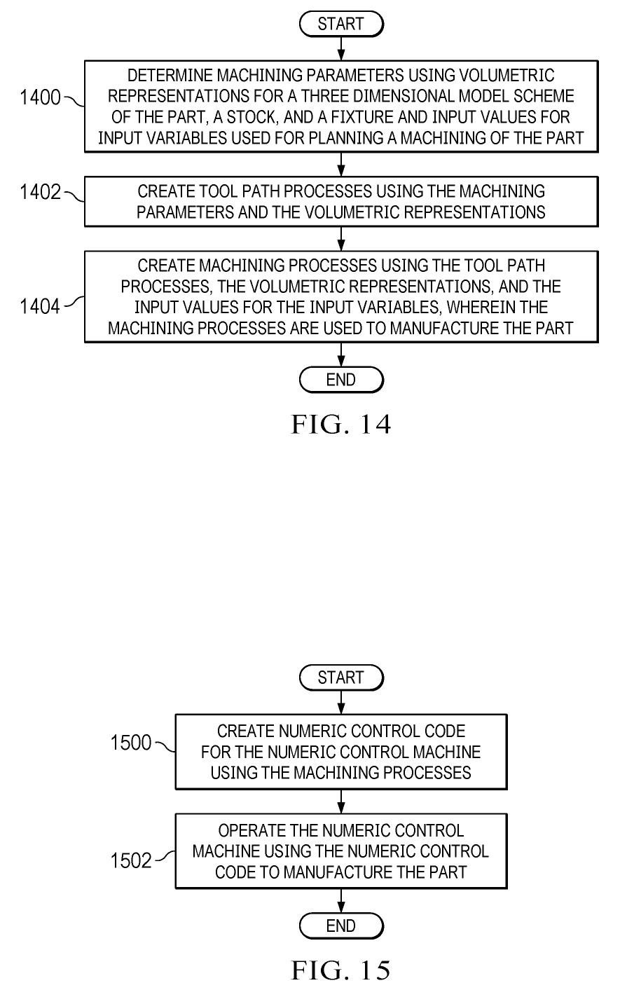

Next in FIG. 14, an illustration of a flowchart of a process for manufacturing a part is depicted in accordance with an illustrative embodiment. The process in FIG. 14 can be implemented in hardware, software, or both. When implemented in software, the process can take the form of program instructions that are run by one of more processor units located in one or more hardware devices in one or more computer systems. For example, the process can be implemented in workflow manager 214 in computer system 212 in FIG. 2.

The process begins by determining machining parameters using volumetric representations for a three dimensional model scheme of the part, a stock, and a fixture and input values for input variables used for planning a machining of the part (operation 1400). The process creates tool path processes using the machining parameters and the volumetric representations (operation 1402).

The process creates machining processes using the tool path processes, the volumetric representations, and the input values for the input variables, wherein the machining processes are used to manufacture the part (operation 1404). The process terminates thereafter.

With reference now to FIG. 15, an illustration of a flowchart of a process for manufacturing a part is depicted in accordance with an illustrative embodiment. The process illustrated in this figure is an example of additional operations that can be performed with the operations in FIG. 14.

The process begins by creating numeric control code for the numeric control machine using the machining processes (operation 1500). The process operates the numeric control machine using the numeric control code to manufacture the part (operation 1502). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

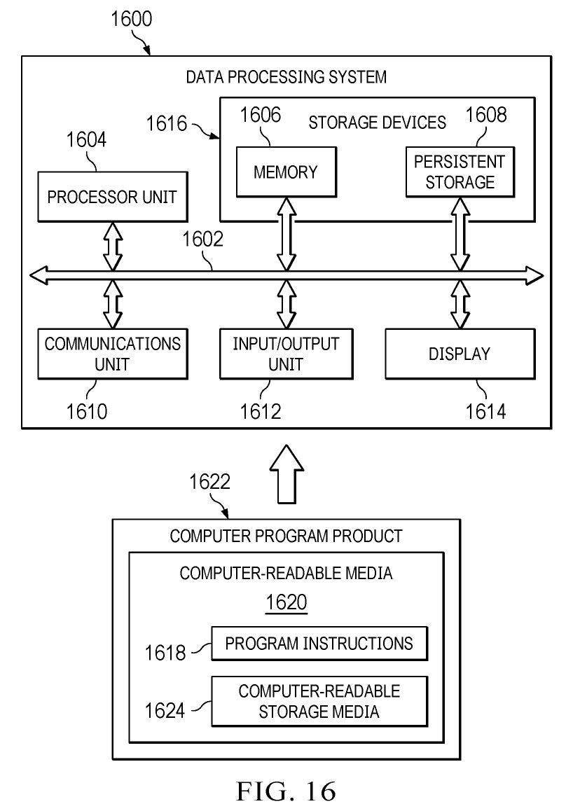

Turning now to FIG. 16, an illustration of a block diagram of a data processing system is depicted in accordance with an illustrative embodiment. Data processing system 1600 can be used to implement server computer 104, server computer 106, client devices 110, in FIG. 1. Data processing system 1600 can also be used to implement computer system 212 in FIG. 2. In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1604 can be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are referred to as program instructions, computer usable program instructions, or computer-readable program instructions that can be read and executed by a processor in processor unit 1604. The program instructions in the different embodiments can be embodied on different physical or computer-readable storage media, such as memory 1606 or persistent storage 1608.

Program instructions 1618 are located in a functional form on computer-readable media 1620 that is selectively removable and can be loaded onto or transferred to data processing system 1600 for execution by processor unit 1604. Program instructions 1618 and computer-readable media 1620 form computer program product 1622 in these illustrative examples. In the illustrative example, computer-readable media 1620 is computer-readable storage media 1624.

Computer readable storage media 1624 is a physical or tangible storage device used to store program instructions 1618 rather than a medium that propagates or transmits program instructions 1618. Computer readable storage media 1624 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits / lands formed in a major surface of a disc, or any suitable combination thereof.

Computer readable storage media 1624, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1618 can be transferred to data processing system 1600 using a computer-readable signal media. The computer-readable signal media are signals and can be, for example, a propagated data signal containing program instructions 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program instructions 1618 can be located in computer-readable media 1620 in the form of a single storage device or system. In another example, program instructions 1618 can be located in computer-readable media 1620 that is distributed in multiple data processing systems. In other words, some instructions in program instructions 1618 can be located in one data processing system while other instructions in program instructions 1618 can be located in one data processing system. For example, a portion of program instructions 1618 can be located in computer-readable media 1620 in a server computer while another portion of program instructions 1618 can be located in computer-readable media 1620 located in a set of client computers.

The different components illustrated for data processing system 1600 are not meant to provide architectural limitations to the manner in which different embodiments can be implemented. In some illustrative examples, one or more of the components may be incorporated in or otherwise form a portion of, another component. For example, memory 1606, or portions thereof, may be incorporated in processor unit 1604 in some illustrative examples. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program instructions 1618.

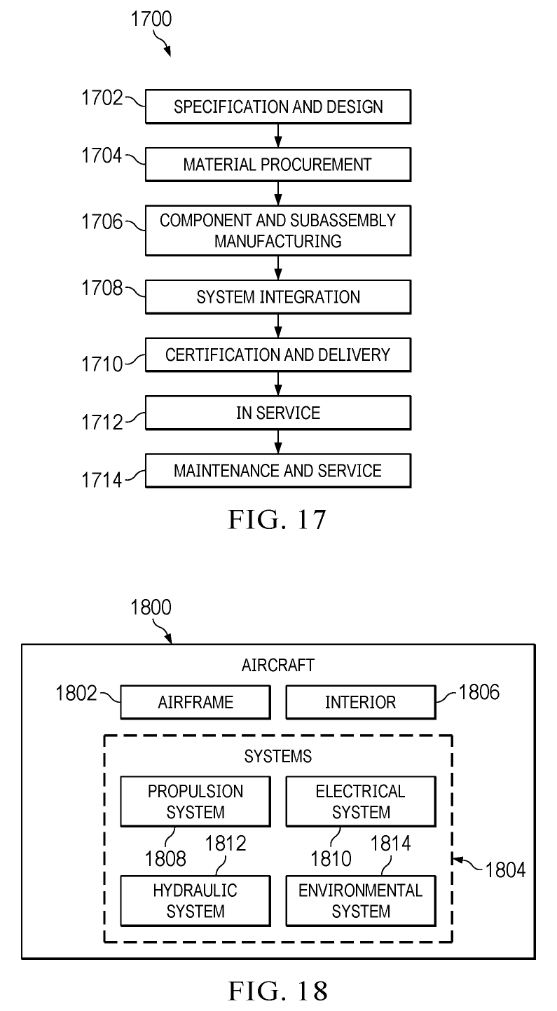

Illustrative embodiments of the disclosure may be described in the context of aircraft manufacturing and service method 1700 as shown in FIG. 17 and aircraft 1800 as shown in FIG. 18. Turning first to FIG. 17, an illustration of a block diagram of an aircraft manufacturing and service method is depicted in accordance with an illustrative embodiment. During pre-production, aircraft manufacturing and service method 1700 may include specification and design 1702 of aircraft 1800 in FIG. 18 and material procurement 1704.

During production, component and subassembly manufacturing 1706 and system integration 1708 of aircraft 1800 in FIG. 18 takes place. Thereafter, aircraft 1800 in FIG. 18 can go through certification and delivery 1710 in order to be placed in service 1712. While in service 1712 by a customer, aircraft 1800 in FIG. 18 is scheduled for routine maintenance and service 1714, which may include modification, reconfiguration, refurbishment, and other maintenance or service.

Each of the processes of aircraft manufacturing and service method 1700 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 18, an illustration of a block diagram of an aircraft is depicted in which an illustrative embodiment may be implemented. In this example, aircraft 1800 is produced by aircraft manufacturing and service method 1700 in FIG. 17 and may include airframe 1802 with plurality of systems 1804 and interior 1806. Examples of systems 1804 include one or more of propulsion system 1808, electrical system 1810, hydraulic system 1812, and environmental system 1814. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1700 in FIG. 17.

In one illustrative example, components or subassemblies produced in component and subassembly manufacturing 1706 in FIG. 17 can be fabricated or manufactured in a manner similar to components or subassemblies produced while aircraft 1800 is in service 1712 in FIG. 17. As yet another example, one or more apparatus embodiments, method embodiments, or a combination thereof can be utilized during production stages, such as component and subassembly manufacturing 1706 and system integration 1708 in FIG. 17. One or more apparatus embodiments, method embodiments, or a combination thereof may be utilized while aircraft 1800 is in service 1712, during maintenance and service 1714 in FIG. 17, or both. The use of a number of the different illustrative embodiments may substantially expedite the assembly of aircraft 1800, reduce the cost of aircraft 1800, or both expedite the assembly of aircraft 1800 and reduce the cost of aircraft 1800.

In this illustrative example, workflow manager 214 in manufacturing system 202 can be used during one or more of the different stages in manufacturing and service method 1700. For example, workflow manager 214 can be used during component and subassembly manufacturing 1706 to manufacture parts for aircraft 1800. As another example, workflow manager 214 can also be used during maintenance and service 1714 to manufacture parts for modification, reconfiguration, refurbishment, and other maintenance or service of aircraft 1800.

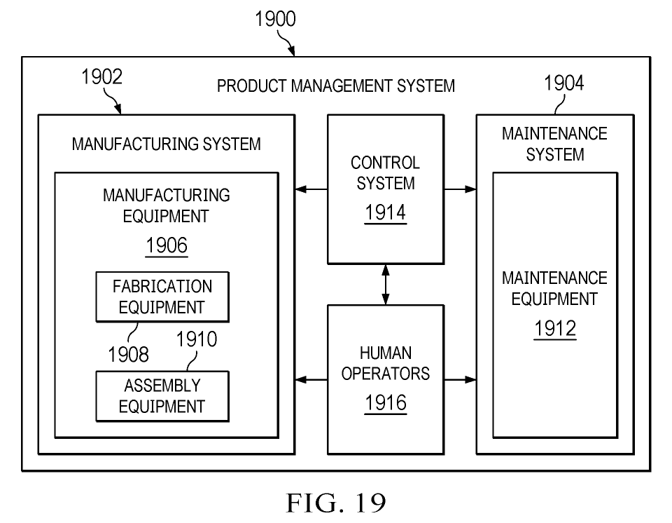

Turning now to FIG. 19, an illustration of a block diagram of a product management system is depicted in accordance with an illustrative embodiment. Product management system 1900 is a physical hardware system. In this illustrative example, product management system 1900 includes at least one of manufacturing system 1902 or maintenance system 1904.

Manufacturing system 1902 is configured to manufacture products, such as aircraft 1800 in FIG. 18. As depicted, manufacturing system 1902 includes manufacturing equipment 1906. Manufacturing equipment 1906 includes at least one of fabrication equipment 1908 or assembly equipment 1910.

Fabrication equipment 1908 is equipment that is used to fabricate components or parts used to form aircraft 1800 in FIG. 18. For example, fabrication equipment 1908 can include machines and tools. These machines and tools can be at least one of a drill, a hydraulic press, a furnace, an autoclave, a mold, a composite tape laying machine, an automated fibre placement (AFP) machine, a vacuum system, a robotic pick and place system, a flatbed cutting machine, a laser cutter, a computer numerical control (CNC) cutting machine, a lathe, or other suitable types of equipment. Fabrication equipment 1908 can be used to fabricate at least one of metal parts, composite parts, semiconductors, circuits, fasteners, ribs, skin panels, spars, antennas, or other suitable types of parts.

Assembly equipment 1910 is equipment used to assemble parts to form aircraft 1800 in FIG. 18. In particular, assembly equipment 1910 is used to assemble components and parts to form aircraft 1800 in FIG. 18. Assembly equipment 1910 also can include machines and tools. These machines and tools may be at least one of a robotic arm, a crawler, a fastener installation system, a rail-based drilling system, or a robot. Assembly equipment 1910 can be used to assemble parts such as seats, horizontal stabilizers, wings, engines, engine housings, landing gear systems, and other parts for aircraft 1800 in FIG. 18.

In this illustrative example, maintenance system 1904 includes maintenance equipment 1912. Maintenance equipment 1912 can include any equipment needed to perform maintenance on aircraft 1800 in FIG. 18. Maintenance equipment 1912 may include tools for performing different operations on parts on aircraft 1800 in FIG. 18. These operations can include at least one of disassembling parts, refurbishing parts, inspecting parts, reworking parts, manufacturing replacement parts, or other operations for performing maintenance on aircraft 1800 in FIG. 18. These operations can be for routine maintenance, inspections, upgrades, refurbishment, or other types of maintenance operations.

In the illustrative example, maintenance equipment 1912 may include ultrasonic inspection devices, x-ray imaging systems, vision systems, drills, crawlers, and other suitable devices. In some cases, maintenance equipment 1912 can include fabrication equipment 1908, assembly equipment 1910, or both to produce and assemble parts that needed for maintenance.

Product management system 1900 also includes control system 1914. Control system 1914 is a hardware system and may also include software or other types of components. Control system 1914 is configured to control the operation of at least one of manufacturing system 1902 or maintenance system 1904. In particular, control system 1914 can control the operation of at least one of fabrication equipment 1908, assembly equipment 1910, or maintenance equipment 1912.

In one example, workflow manager 214 can be used in control system 1914 to control the operation of at least one of manufacturing system 1902 to manufacture parts for manufacturing aircraft or for use in maintenance system 1904 to maintain aircraft. For example, workflow manager 214 can create numeric control program code for operating numeric control machines at least one of in fabrication equipment 1908 or maintenance equipment 1912.

For example, numeric control program code generated by workflow manager 214 can be used to operate fabrication equipment 1908 to manufacture parts for use in manufacturing aircraft 1800 in FIG. 18. In another example, workflow manager 214 can be used to operate maintenance equipment 1912 to manufacture parts for use in maintenance to perform at least one of modification, reconfiguration, refurbishment, or other maintenance or service of aircraft 1800 in FIG. 18.

The hardware in control system 1914 can be implemented using hardware that may include computers, circuits, networks, and other types of equipment. The control may take the form of direct control of manufacturing equipment 1906. For example, robots, computer-controlled machines, and other equipment can be controlled by control system 1914. In other illustrative examples, control system 1914 can manage operations performed by human operators 1916 in manufacturing or performing maintenance on aircraft 1800. For example, control system 1914 can assign tasks, provide instructions, display models, or perform other operations to manage operations performed by human operators 1916. In these illustrative examples, workflow manager 214 from FIG. 2 can be implemented in control system 1914 to manage at least one of the manufacturing or maintenance of aircraft 1800 in FIG. 18.

In the different illustrative examples, human operators 1916 can operate or interact with at least one of manufacturing equipment 1906, maintenance equipment 1912, or control system 1914. This interaction can occur to manufacture aircraft 1800 in FIG. 18.

Of course, product management system 1900 may be configured to manage other products other than aircraft 1800 in FIG. 18. Although product management system 1900 has been described with respect to manufacturing in the aerospace industry, product management system 1900 can be configured to manage products for other industries. For example, product management system 1900 can be configured to manufacture products for the automotive industry as well as any other suitable industries.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A manufacturing system for manufacturing a part, the manufacturing system comprising:
a computer system; and
workflow manager in the computer system, wherein the workflow manager is configured to perform operations comprising:
creating volumetric representations for a three dimensional model scheme of the part, a stock, and a fixture for holding the part;
determining values for input variables used for planning a machining of the part;
determining machining parameters using the volumetric representations and the values for the input variables;
creating tool path processes using the machining parameters and the volumetric representations; and
creating machining processes using the tool path processes, the volumetric representations, and input values for the input variables, wherein the machining processes are used to manufacture the part.

2. The manufacturing system of claim 1, wherein the workflow manager is configured to perform the operations comprising:
controlling an operation of a numeric control machine to machine the stock to form the part using the machining processes.

3. The manufacturing system of claim 2, wherein in controlling the operation of the numeric control machine, the workflow manager is configured to perform the operations comprising:
creating numeric control code for the numeric control machine using the machining processes; and
operating the numeric control machine using the numeric control code to manufacture the part.

4. The manufacturing system of claim 3, wherein in creating the numeric control code, the workflow manager is configured to perform the operations comprising:
converting the machining processes from a generic form to the numeric control code that is specific to the numeric control machine.

5. The manufacturing system of claim 1, wherein the tool path processes, the volumetric representations, and the input values for the input variables form a template.

6. The manufacturing system of claim 1, wherein the volumetric representations and the input values for the input variables are in a standardized format.

7. The manufacturing system of claim 1, wherein the tool path processes are in a standardized format.

8. The manufacturing system of claim 1, wherein in creating the volumetric representations, the workflow manager is configured to perform the operations comprising:
creating a first collection of triangles for a part surface of the part in the three dimensional model scheme;
determining a first volume of the part in the three dimensional model scheme using the first collection of triangles;
creating a second collection of triangles for a stock surface of the stock in the three dimensional model scheme;
determining a second volume of the stock in the three dimensional model scheme using the second collection of triangles;
creating a third collection of triangles for a fixture surface of the fixture in the three dimensional model scheme; and
determining a third volume of the fixture in the three dimensional model scheme using the third collection of triangles, wherein the first volume, the second volume, and the third volume are the volumetric representations for the three dimensional model scheme of the part, the stock, and the fixture for the part.

9. The manufacturing system of claim 1, wherein in creating the tool path processes, the workflow manager is configured to perform the operations comprising:
identifying optimal tool path processes using a machine learning model system and the machining parameters.

10. The manufacturing system of claim 1, wherein the volumetric representations are also for a number of split surfaces.

11. The manufacturing system of claim 1, wherein the input variables are selected from at least one of a ratio of depth to width, a surface clearance, a split surface clearance, a surface offset, a split surface offset, a stock height, a number of levels, a ratio depth to width, a maximum pocket width, a minimum pocket width, a smallest corner radius, a smallest fillet radius, a clearance, a cutting speed, a feed rate, a cutting depth, a cutting width, a spindle speed for a cutting tool, a tool geometry, an offset, a pattern type, a lowest cut level offset, a fixture clearance, a minimum thickness, or the stock to leave and wherein the machining parameters are selected from at least one of a maximum tilt angle, an axial offset, a minimum width, a maximum step over, a keller finish, a depth step, a cusp height, a stepover, a depth of cut, a link motion, a tolerance, or machine control statement.

12. The manufacturing system of claim 2, wherein the numeric control machine is selected from a group comprising a two dimensional numeric control machine, a three dimensional numeric control machine, a milling machine, a grinding machine, a lathe, a plasma cutter, a laser cutter, and a water jet cutter.

13. A manufacturing system comprising:
a computer system; and
workflow manager in the computer system, wherein the workflow manager is configured to perform operations comprising:
determining machining parameters using volumetric representations of a part, a stock, and a fixture in a three dimensional model scheme and input values for input variables used for planning a machining of the part;
creating tool path processes using the machining parameters and the volumetric representations; and
creating machining processes using the tool path processes, the volumetric representations, and the input values for the input variables, wherein the machining processes are used to manufacture the part.

14. The manufacturing system of claim 13 further comprising:
a numeric control machine; and
wherein the workflow manager is configured to perform the operations comprising:
controlling an operation of the numeric control machine to machine the stock to form the part using the machining processes.

15. The manufacturing system of claim 14, wherein in controlling the operation of the numeric control machine, the workflow manager is configured to perform the operations comprising:
creating numeric control code for the numeric control machine using the machining processes; and
operating the numeric control machine using the numeric control code to manufacture the part.

16. The manufacturing system of claim 15, wherein in creating the numeric control code, the workflow manager is configured to perform the operations comprising:
converting the machining processes from a generic form to the numeric control code that is specific to the numeric control machine.

17. A method for manufacturing a part, the method comprising:
creating volumetric representations for a three dimensional model scheme of the part, a stock, and a fixture for holding the part;
determining input values for input variables used for planning a machining of the part;
determining machining parameters using the volumetric representations and the input values for the input variables;
creating tool path processes using the machining parameters and the volumetric representations; and
creating machining processes using the tool path processes, the volumetric representations, and the input values for the input variables, wherein the machining processes are used to manufacture the part.

18. The method of claim 17 further comprising:
controlling an operation of a numeric control machine to machine the stock to form the part using the machining processes.

19. The method of claim 18, wherein controlling the operation of the numeric control machine comprises:
creating a numeric control code for the numeric control machine using machining processes; and
operating the numeric control machine using the numeric control code to manufacture the part.

20. The method of claim 19, wherein creating the numeric control code comprises:
converting the machining processes from a generic form to the numeric control code that is specific to the numeric control machine.

21. A method for manufacturing a part, the method comprising:
determining machining parameters using volumetric representations for a three dimensional model scheme of the part, a stock, and a fixture and input values for input variables used for planning a machining of the part;
creating tool path processes using the machining parameters and the volumetric representations; and
creating machining processes using the tool path processes, the volumetric representations, and the input values for the input variables, wherein the machining processes are used to manufacture the part.
